(19) United States
(12) Patent Application Publication
(10) Pub. No.: US 2017/0186035 A1
(43) Pub. Date: Jun. 29, 2017

(54) METHOD OF AND SERVER FOR SELECTION OF A TARGETED MESSAGE FOR PLACEMENT INTO A SEARCH ENGINE RESULT PAGE IN RESPONSE TO A USER SEARCH REQUEST

(71) Applicant: YANDEX EUROPE AG, Luzern (CH)

(72) Inventors: Mikhail Vladimirovich LEVIN, Moscow (RU); Ivan Yurievich PODOGOV, Moscow (RU)

(21) Appl. No.: 15/324,293

(22) PCT Filed: Jan. 7, 2015
(86) PCT No.: PCT/IB15/50109

§ 371 Date: Jan. 6, 2017

(30) Foreign Application Priority Data
Jul. 7, 2014 (RU) 2014127401

(51) Int. Cl. G06Q 30/02; G06F 17/30

(52) U.S. Cl. CPC G06Q 30/0256; G06F 17/30867; G06F 17/30554; G06Q 30/0246

(57) ABSTRACT

There is disclosed a method of and a system for selecting a targeted message for inclusion into a Search Engine Results Page (SERP). The method is executable at a server coupled to an electronic device via a communication network. The method comprises: receiving, from the electronic device via the communication network, the search request; generating the SERP, the SERP including at least one search result responsive to the search request; determining if the search request is a navigational search request; responsive to the search request being the navigational search request, determining a web resource being associated with the navigational search request; retrieving, from a targeted messages database, a targeted message being associated with an entity associated with the web resource; transmitting to the user electronic device a command signal, the command signal for causing the electronic device to display the SERP with the targeted message displayed therein.

### CROSS-REFERENCE

The present application claims priority to Russian Patent Application No. 2014127401, filed Jul. 7, 2014, entitled “METHOD OF AND A SERVER FOR SELECTION OF A TARGETED MESSAGE FOR PLACEMENT INTO A SEARCH ENGINE RESULT PAGE IN RESPONSE TO A USER SEARCH REQUEST” the entirety of which is incorporated herein.

### FIELD

The present technology relates to search engines in general, and to method of and server for selection of a targeted message for placement into a search engine result page in response to a user search request.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communications network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

There are numerous search engines available to the user. Some of them are considered to be general purpose search engines (such as Yandex™, Google™, Yahoo™and the like). Others are considered to be vertical search engines—i.e. search engines dedicated to a particular topic of search—such as Momondo™search engine dedicated to searching flights.

Irrespective of which search engine is used, the search engine is generally configured to receive a search query from a user, to perform a search and to return a ranked search engine results page (SERP) to the user. Now, generally, the search engines do not charge users for performing searches. As most search engines are commercial enterprises—they need to generate revenue streams to support their commercial operations. Most search engines generate revenue through advertising—i.e. a placement of ads within the SERP or providing ads to other entities (such as web sites) for paid placements. Naturally, the search engines strive to make the ads as relevant to the user as possible to increase the chances that the user will actually click on the ads and the search engine will actually get paid by the provider of the ad (pay-per-click concept).

For example, if the user is looking for to buy a kitten and, as such, the user has submitted a search query “purchase kittens in Moscow”, the user can be presented with an ad of a veterinary clinic in Moscow region. As the user is inherently is interested in kitten and may require a vet, the ad associated with the veterinary clinic may have a higher chance of being clicked.

This is what is known in the art as “targeted advertising”—selecting a particular targeted message based on explicit or implicit user interests ad presenting the particular targeted message within the SERP are known.

U.S. patent application 20120166277 published on Jun. 28, 2012 to Gnanamani teaches a method whereby query threshold values are determined to be used to select advertisements to be displayed in response to a search query. A query threshold value is determined for each query based on query attributes characterizing the query, such as a query frequency, query length, whether the query is a navigational query, etc. By generating a threshold value for each query, and using the query threshold value for selecting advertisements to be displayed for the query (e.g., selecting advertisements having quality scores greater than the query threshold value), the advertisements can better correspond to the query, and thus are more likely to be selected by the user. As a result, the user experience can be enhanced and the advertising revenue can be correspondingly increased.

### SUMMARY

It is an object of the present technology to ameliorate at least some of the inconveniences present in the prior art.

According to a first broad aspect of the present technology, there is provided a method of selecting a targeted message for inclusion into a Search Engine Results Page (SERP). The method is executable at a server coupled to an electronic device via a communication network. The method comprises: receiving, from the electronic device via the communication network, a search request; generating the SERP, the SERP including at least one search result responsive to the search request; determining if the search request is a navigational search request; responsive to the search request being the navigational search request, determining a web resource being associated with the navigational search request; retrieving, from a targeted messages database, a targeted message being associated with an entity associated with the web resource; transmitting to the user electronic device a command signal, the command signal for causing the electronic device to display the SERP with the targeted message displayed therein.

In some implementations of the method, the retrieving comprises retrieving a plurality of targeted messages associated with the entity and wherein the method further comprises selecting the targeted message from the plurality of targeted messages.

In some implementations of the method, the selecting comprises applying a targeted messages policy to the plurality of targeted messages.

In some implementations of the method, the command signal is for causing the electronic device to display the SERP with at least some of the plurality of targeted messages displayed therein in a rotating carousel fashion.

In some implementations of the method, the determining if the search request is a navigational search request comprises analyzing the search request and a geo location associated with the electronic device.

In some implementations of the method, the determining if the search request is a navigational search request comprises analyzing a top search result generated for the search request.

In some implementations of the method, the determining if the search request is a navigational search request comprises analyzing past click information, past click information being representative of a most frequent resource selected by other users performing past searches similar to the search request.

In some implementations of the method, the method further comprises determining a special placement of the targeted message within the SERP.

In some implementations of the method, the determining comprises applying a targeting policy to determine the special placement.

In some implementations of the method, the determining comprises selecting the special placement on a top portion of the SERP above the at least one search result.

In some implementations of the method, the determining a web resource being associated with the navigational search request comprises selecting the web resource based on its URL.

In some implementations of the method, the method further comprises, prior to the receiving, uploading the targeted message to the targeted messages database.

In some implementations of the method, the uploading further comprises associating the targeted message with an indication of the web resource.

In some implementations of the method, the retrieving the targeted message being associated with an entity associated with the web resource is executed using the indication of the web resource.

In some implementations of the method, the generating the SERP comprises including a link to the web resource as part of a set of top search results.

In some implementations of the method, the method further comprises, prior to the retrieving, adjusting a predicted click-through rate of the targeted message to an adjusted click-through rate.

In some implementations of the method, the retrieving is executed on the basis of the adjusted click-through rate.

In some implementations of the method, the adjusted click-through rate is higher than the predicted click-through rate.

In some implementations of the method, the targeted message is a banner ad.

According to another broad aspect of the present technology, there is provided a server. The server comprises: a communication interface for communication with an electronic device via a communication network, a processor operationally connected with the communication interface, the processor configured to: receive, from an electronic device via a communication network, a search request; generate the SERP, the SERP including at least one search result responsive to the search request; determine if the search request is a navigational search request; responsive to the search request being the navigational search request, determine a web resource being associated with the navigational search request; retrieve, from a targeted messages database, a targeted message being associated with an entity associated with the web resource; transmit to the user electronic device a command signal, the command signal for causing the electronic device to display the SERP with the targeted message displayed therein.

In some implementations of the server, to retrieve, the processor is configured to retrieve a plurality of targeted messages associated with the entity and wherein the processor is further configured to select the targeted message from the plurality of targeted messages.

In some implementations of the server, to select, the processor is configured to apply a targeted messages policy to the plurality of targeted messages.

In some implementations of the server, the command signal is for causing the electronic device to display the SERP with at least some of the plurality of targeted messages displayed therein in a rotating carousel fashion.

In some implementations of the server, to determine if the search request is a navigational search request, the processor is configured to analyze the search request and a geo location associated with the electronic device.

In some implementations of the server, to determine if the search request is a navigational search request, the processor is configured to analyze a top search result generated for the search request.

In some implementations of the server, to determine if the search request is a navigational search request, the processor is configured to analyze past click information, past click information being representative of a most frequent resource selected by other users performing past searches similar to the search request.

In some implementations of the server, the processor is being further configured to determine a special placement of the targeted message within the SERP.

In some implementations of the server, to determine a special placement of the targeted message within the SERP, the processor is configured to apply a targeting policy to determine the special placement.

In some implementations of the server, to determine a special placement of the targeted message within the SERP, the processor is configured to select the special placement on a top portion of the SERP above the at least one search result.

In some implementations of the server, to determine a web resource being associated with the navigational search request, the processor is configured to select the web resource based on its URL.

In some implementations of the server, the processor is being further configured, prior to executing receiving, upload the targeted message to the targeted messages database.

In some implementations of the server, to upload, the server is further configured to associate the targeted message with an indication of the web resource.

In some implementations of the server, to retrieve the targeted message being associated with an entity associated with the web resource, the processor is configured to execute using the indication of the web resource.

In some implementations of the server, to generate the SERP, the processor is configured to include a link to the web resource as part of a set of top search results.

In some implementations of the server, the processor being further configured, prior to the retrieving, to adjust a predicted click-through rate of the targeted message to an adjusted click-through rate.

In some implementations of the server, to retrieve, the processor is configured to retrieve on the basis of the adjusted click-through rate.

In some implementations of the server, the adjusted click-through rate is higher than the predicted click-through rate.

In some implementations of the server, the targeted message is a banner ad.

In the context of the present specification, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as a electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “relevance factor of the search query result set” shall mean the likelihood that the user submitting the search query was intending to see data maintained within the search query result set.

In the context of the present specification, the expression “component” is meant to include software (appropriate to a particular hardware context) that is both necessary and sufficient to achieve the specific function(s) being referenced.

In the context of the present specification, the expression a “search query result set” is a listing of results returned by a search engine, which may encompass one or more general or specialized search modules, in response to a search query. Search query result set may contain a listing of results returned by a web search module, or by one or more vertical search modules, or by combination of results returned by web module and one or more vertical modules. The search query result set may also contain no results.

In the context of the present specification, the expression a “search engine result page” is a listing of results to be displayed to a client on an electronic device, the listing generated by combining a search query result set with targeted messages.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram showing a system 100 suitable for implementing embodiments of the present technology.

FIG. 2 is a flow chart depicting a method 200 executed within the system 100, the method 200 being implemented in accordance with non-limiting embodiments of the present technology.

### DETAILED DESCRIPTION

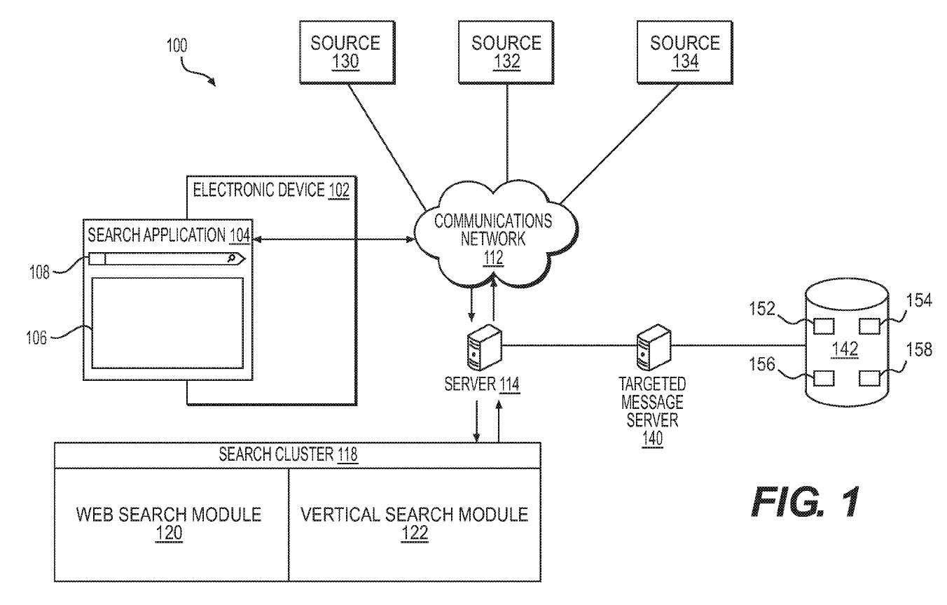

Referring to FIG. 1, there has been shown a diagram of a networked computer system 100. It is to be expressly understood that the computer system 100 is merely one possible implementation of the present technology. Thus, the description thereof that follows is intended to be only a description of illustrative examples of the present technology. This description is not intended to define the scope or set forth the bounds of the present technology. In some cases, what are believed to be helpful examples of modifications to computer system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the computer system 100 may provide in certain instances a simple implementation of the present technology, and that where such is the case they have been presented in this manner as an aid to understanding. As persons skilled in the art would understand, various implementations of the present technology may be of a greater complexity.

FIG. 1 illustrates a system 100 in accordance with one implementation of the present technology. The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.), a wireless electronic device (a cell phone, a smartphone, a tablet and the like), as well as network equipment (a router, a switch, or a gateway). The general implementation of the electronic device 102 is known in the art and, as such, will not be described here at much length. Suffice it to say that the electronic device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over a communications network 112; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

The electronic device 102 comprises hardware and/or software and/or firmware (or a combination thereof), a search application 104. Generally speaking, the purpose of the search application 104 is to enable the user to execute a search. How the search application 104 is implemented is not particularly limited. One example of the search application 104 may be embodied in a user accessing a web site associated with a search engine to access the search application 104 using a web browser. For example, the search application can be accessed by typing in an URL associated with Yandex search engine at www.yandex.ru into the web browser. It should be expressly understood that the search application 104 can be accessed using any other commercially available or proprietary search engine.

In alternative non-limiting embodiments of the present technology, the search application 104 may be implemented as a browser application on a portable device (such as a wireless communication device). For example (but not limited) to those implementations, where the electronic device 102 is implemented as a portable device, such as for example, Samsung™ Galaxy™ SIII, the electronic device may be executing a Yandex browser application. It should be expressly understood that any other commercially available or proprietary browser application can be used for implementing non-limiting embodiments of the present technology.

Generally, speaking, the search application 104 comprises a web browser interface 106 and an omnibox 108. The general purpose of the omnibox 108 is to enable the user 140 to enter her query or a “search string” or an URL associated with the web resource she is desirous of visiting. The general purpose of the web browser interface 106 is to provide search results that are responsive to the user query entered into the omnibox 108 or to display the web resource which URL is entered into the omnibox 108. How the user query is processed and how the search results are presented will be described in detail herein below.

Furthermore, the system 100 comprises the above-mentioned communications network 112. In some non-limiting embodiments of the present technology, the communications network 112 can be implemented as the Internet. In other embodiments of the present technology, the communications network 112 can be implemented differently, such as any wide-area communications network, local-area communications network, a private communications network and the like.

The system 100 further comprises a server 114 coupled to the communications network 112 via a communication link (not separately numbered). The server 114 can be implemented as a conventional computer server. In an example of an embodiment of the present technology, the server 114 can be implemented as a Dell™ PowerEdge™ Server running the Microsoft™ Windows Server™ operating system. Needless to say, the server 114 can be implemented in any other suitable hardware and/or software and/or firmware or a combination thereof. In the depicted non-limiting embodiment of present technology, the server 114 is a single server. In alternative non-limiting embodiments of the present technology, the functionality of the server 114 may be distributed and may be implemented via multiple servers.

The implementation of the server 114 is well known. However, briefly speaking, the server 114 comprises a communication interface (not depicted) structured and configured to communicate with various entities (such as the electronic device 102, for example and other devices potentially coupled to the communications network 112) via the communications network 112. The server 114 further comprises at least one computer processor (not depicted) operationally connected with the communication interface and structured and configured to execute various processes to be described herein.

In some embodiments, the server 114 can be operated by the same entity that has provided the afore-described search application 104. In alternative embodiments, the server 114 can be operated by an entity different from the one who has provided the afore-mentioned search application 104.

The server 114 is communicatively coupled (or otherwise has access) to a search cluster 118. As such, the server 114 can be sometimes referred to as a “search server” or a “search front-end server”. Even though the search cluster 118 is depicted as a separate server from the server 114, in alternative embodiments, the functionality of the search cluster 118 can be implemented by the server 114. In alternative non-limiting embodiments of the present technology, the functionality of the search cluster 118 may be distributed and may be implemented via multiple servers.

The general purpose of the search cluster 118 is to perform searches in response to the user queries inputted via the omnibox 108 and to output search results to be presented to the user using the web browser interface 106. What follows is a description of one non-limiting embodiment of the implementation for the search cluster 118. However, it should be understood that there is a number of alternative non-limiting implementations of the search cluster 118 possible. It should be also expressly understood that in order to simplify the description presented herein below, the configuration of the search cluster 118 has been greatly simplified. It is believed that those skilled in the art will be able to appreciate implementational details for the search cluster 118 and for components thereof that may have been omitted for the purposes of simplification of the description.

Generally speaking the purpose of the search cluster 118 is to (i) conduct searches (details will be explained herein below); (ii) execute analysis of search results and perform ranking of search results; (iii) group results and compile the search result page (SERP) to be outputted to the electronic device 402 as the SERP. How the search cluster 118 is configured to execute searches is not particularly limited. Those skilled in the art will appreciate several ways and means to execute the search using the search cluster 118 and as such, several structural components of the search cluster 118 will only be described at a high level.

In some embodiments of the present technology, the search cluster 118 can execute several searches, including but not limited to, a general search and a vertical search. Thus, in some non-limiting embodiments of the present technology, the search cluster 118 comprises (or, otherwise, has access to) a web search module 120 and a vertical search module 422. The web search module 120 is configured to perform general web searches, as is known to those of skill in the art. The vertical search module 122 is configured to execute one or more vertical searches, such as an images vertical search, a music vertical search, a video vertical search, a news vertical search, a maps vertical search and the like.

In some non-limiting embodiments of the present technology, the search cluster 118 can execute what is known as a multi-level search. These non-limiting embodiments can be implemented, for example, to increase the speed of the search and to obtain more relevant search results. Briefly, the search cluster 118 can execute some or all of a top level meta search, a middle level meta search and a bottom level search of the indexed web resources, an indication of which is stored in an index (not depicted) associated with the web search module 420. To that end, the search cluster 118 is also configured to, as is known to those of skill in the art, execute a crawler algorithm—which algorithm causes the search cluster 118 to “crawl” the Internet and index visited web sites into one or more of the index databases (not depicted).

In parallel or in sequence with the general web search executed by the web search module 420, the vertical search module 122 is configured to perform one or more vertical searches within the respective vertical databases (not depicted). For the purposes of the description presented herein, the term “vertical” (as in vertical search) is meant to connote a search performed on a subset of a larger set of data, the subset having been grouped pursuant to an attribute of data. For example, to the extent that the one of the vertical searches performed by the vertical search module 122 is an image service, the vertical search module 122 can be said to search a subset (i.e. images) of the set of data (i.e. all the data potentially available for searching), the subset of data being stored in the database (not depicted) associated with the vertical search module 422. Needless to say that even though a single one of the vertical search module 122 is depicted in FIG. 4, the search cluster 118 can implement multiple instances of the vertical search modules 422, each of the vertical search modules 422 being responsible for executing a respective vertical search.

Now, once the web search module 120 and the vertical search module 122 return their respective search results, the search cluster 118 is configured to generate a ranked search results list, including the results from the web search module 120 and the vertical search module 122. Multiple algorithms for ranking the search results are known and can be implemented by the search cluster 118.

Just as an example and not as a limitation, some of the known techniques for ranking search results by relevancy to the user-submitted search query are based on some or all of: (i) how popular a given search query or a response thereto is in searches conducted by either the web search module 120 or the vertical search module 122; (ii) how many results have been returned by either the web search module 120 or the vertical search module 122; (iii) whether the search query contains any determinative terms (such as “images”, “movies”, “weather” or the like), (iv) how often a particular search query is typically used with determinative terms by other users; and (v) how often other uses performing a similar search have selected a particular resource or a particular vertical search results when results were presented using the SERP.

Within this description, the term “determinative term” shall mean a word or a string of words indicative of the fact that a given search result is more likely to have the most relevant response to the user search query. For example, if the search query contains the term “images” it can be determined, by the search cluster 118 that the vertical search module 122 executing the images vertical search is likely to be the service that contains the most relevant results to the user query.

Needless to say, only a sub set of these, or these combined to others or any combination of other factors may be taken into account when raking the search results for relevancy.

The search cluster 118 is then configured to transmit ranked search results to the server 114. The server 114 can then transmits, via the communications network 114, the ranked search results to the electronic device 402 for display to the user as the SERP 306.

Typically, the server 114 can be configured to generate a JavaScript Object Notation (JSON) message, the JSON message containing information that is instrumental for causing the electronic device 102 to display the SERP containing the ranked search results produced by the search cluster 118. Needless to say the message can be in formats other than JSON, such as Extensible Markup Language (XML) format and the like.

According to embodiments of the present technology, the server 114 is further configured to determine if a given search query submitted by the user using the omnibox 108 can be considered to be a “navigational query”. Within embodiments of the present technology, the term “navigational query” is meant to denote a type of query that expressly or implicitly points to a web site (or, even more broadly, specific web domain or a landing page of the specific web domain) of a particular organization as a response to the search query and, thus, indicated the user interest in that particular organization.

In some embodiments of the present technology, whether a given query is deemed to be navigational query if the query has an absolute answer in a geographical area associated with the user (or the electronic device 102 associated with the user, as a proxy for the user location). For example, if the user searches for “Official City web site” and the user's electronic device 102 location is determined to be in Toronto (for example, using a GPS module built into the electronic device 102), the absolute answer to this search query can be the web site of the City of Toronto located at http://www.toronto.ca/. In this case, the web site of the City of Toronto can be considered to be “vital query response” or a “navigational target” and the associated domain can be considered to be a “vital query domain” or a “navigational target” domain.

Therefore, it can be said that a navigational query is a query issued by a user seeking to navigate to a specific web site, the specific web site being associated with an entity—be it a commercial organization, a place of interest, a persona or the like. A navigational query is a different category from a “discovery query”, which is a type of query issued by a user seeking information about a topic. Discovery queries are characterized by the user seeking information from any source about the topic and, as such, will be satisfied with search results from any such search relevant to the search query.

For example, if the user submits a query “Open a new bank account for new corners in Canada”, this search query can not be considered to be navigations, as any web site of any bank that opens bank accounts for new immigrants in Canada would be responsive to this search query. In other words, the search query does not “navigate” to any particular web site of any particular organization (i.e. bank in this case). Within this scenario, any one of the Canadian banks or credit unions that opens bank accounts for new immigrants would be responsive to the user's search query. Therefore, the query “Open a new bank account for new corners in Canada” is not a navigational query, but is rather a discovery query.

If, on the other hand, the user submits a query “Royal Bank of Canada web site”, this search query is considered to be navigational, as it points towards the web site of the Royal Bank of Canada as likely to be a responsive web site to the user search query. It is hypothesized that if the user submits such a navigational search query, the user would not be satisfied with the search results, unless the web site associated with the organization connected to the search query was at least part of the top search results, if not the top search result. Continuing with our example of Royal Bank of Canada, the user is likely not to be satisfied with the search results if the www.rbc.com web site is not part of the top search results presented to the user by the search engine in response to the submitted search query.

How the server 114 determines that a particular search query is a navigational search query is not particularly limited and several routines can be employed.

In some embodiments of the present technology, the server 114 can analyze log data representative of past searches executed by other users and search results past users have selected, where the past searches have been executed with the same or similar search query.

In some embodiments, the server 114 analyzes the log data with the view to identify the top search result presented to the past users executing same or similar searches. For example, if the top search result is the same in a pre-determined number of prior searches, such the search query can be deemed to be navigational and the associated web site of the top search result can be deemed to be the target of such a navigational query.

In other embodiments, the server 114 analyzes the log data with the view to identify the top search result selected by the past users executing same or similar searches. For example, the server can determine if a particular web site has been selected from the search results, and that particular web site is selected by a pre-determined number of users per day—that can be indicative of the search query to be a navigational query and such the web site can be deemed to be the target of such the navigational query.

For example, let it be assumed that 100,000 people per day execute a search “Royal Bank of Canada” and 80% of searchers, per day, choose the link to www.rbc.com web site presented as part of the search results. Let it be assumed that the threshold for navigational query determination is 70%. As such, the search query “Royal Bank of Canada” can be deemed to be a navigational query with the target web site being www.rbc.com.

As another example, let it be assumed that 45,000 people per day execute a search “Royal Bank of Canada Credit Cards review” and 55% of searchers, per day, choose the link to one of the resource on the www.rbc.com web site presented as part of the search results. Let is further be assumed that another 30% choose the search result associated with credit cards rewards review board at http:/www.rewardscanada.ca/rbc-avion-review.html.

Given the above-assumed threshold for navigational query determination of 70%, this search query “Royal Bank of Canada Credit Cards review” can not be deemed to be a navigational query.

In some embodiments of the present technology, the server 114 determines if the search query is a navigational search query using information representative of the geo location associated with the electronic device 102 that the user uses to submit the search query. There are a number of technologies available for determining the geo location associated with the electronic device 102. These include but are not limited to: using IP address assigned to the electronic device 102, using a built in GPS module of the electronic device 102, using various triangulation techniques and the like.

It should be expressly understood that a number of alternative approaches to determining if a given search query is navigational or not are possible.

Examples of the various techniques available for determining if a given search query is a navigational query are known to those of the skill in the art and embodiments of the present technology are not limited to any specific method. To provide an example, U.S. patent application 20090299964 published on Dec. 3, 2009 by Cameron et al teaches one such method, teachings of which patent application are hereby incorporated by reference in their entirety, in all those jurisdictions where such incorporation by reference is allowed.

U.S. Pat. No. 7,693,865 published on Apr. 6, 2010 to Lu et al teaches another approach to determining if a given query is a navigational query, teachings of which patent are hereby incorporated by reference in their entirety, in all those jurisdictions where such incorporation by reference is allowed.

The server 114 is configured to maintain a mapping of navigational queries, which mapping can be maintained in internal or external memory source (not depicted) and can be referred to “NavigSourceQuery” which maps all various phrases that have been determined to be navigational queries. The NavigSourceQuery maps a given navigational search query to its query identifier, referred to here as NavigSourceQueryID.

The server 114 is also configured to maintain a mapping of target domains for navigational queries—for example, a NavigSourceDomain mapping. The NavigSourceDomain mapping can be maintained using the aforementioned NavigSourceQueryID.

In some embodiments, the target domains can also be associated with a particular geographical region. This is particularly convenient in those embodiments, where the server 114 uses geo location of the electronic device 102 for determining if a given query is a navigational query.

Using the NavigSourceQueryID (and sometimes a geo location information associated with the electronic device 102), the server 114 retrieves the target domain associated with the navigational query.

Within the architecture of the system 100, there is also provided a targeted message server 140 Akin to the server 114, the targeted message server 140 can be implemented as a conventional computer server. In an example of an embodiment of the present technology, the targeted message server 140 can be implemented as a Dell™ PowerEdge™ Server running the Microsoft™ Windows Server™ operating system. Needless to say, the targeted message server 140 can be implemented in any other suitable hardware and/or software and/or firmware or a combination thereof. In the depicted non-limiting embodiment of present technology, the targeted message server 140 is a single server. In alternative non-limiting embodiments of the present technology, the functionality of the targeted message server 140 may be distributed and may be implemented via multiple servers.

The implementation of the targeted message server 140 is well known. However, briefly speaking, the targeted message server 140 comprises a communication interface (not depicted) structured and configured to communicate with various entities (such as the server 114 and other devices potentially coupled to the communications network 112) via the communications network 112. The targeted message server 140 further comprises at least one computer processor (not depicted) operationally connected with the communication interface and structured and configured to execute various processes to be described herein.

Even though the server 114 and the targeted message server 140 have been described as implemented using the same hardware and software, this does not need to be so in every embodiment of the present technology. As such, the targeted message server 140 can be implemented in different hardware/software than the server 114. On the other end of the spectrum of embodiments, the server 114 and the targeted message server 140 can be implemented in a single computing apparatus.

Also provided within the illustration of FIG. 1, is a first source 130, a second source 132 and a third source 134, all coupled to the communications network 112. The first source 130, the second source 132 and the third source 134 are representative of a plurality of sources of targeted message potentially interested in placing targeted messages with the ad service provided by the server 114 and the targeted message server 140.

The targeted message server 140 has access to a targeted messages database 142. The targeted message database 142 stores a plurality of targeted messages from several respective sources (i.e. one of the first source 130, the second source 132 and the third source 134), including a first targeted message 152, a second targeted message 154, a third targeted message 156 and a fourth targeted message 158.

The first targeted message 152, the second targeted message 154, the third targeted message 156 and the fourth targeted message 158 have been uploaded to the targeted message database 142 by their respective sources (i.e. one of the first source 130, the second source 132 and the third source 134) by using an ad service provided by the targeted message server 140.

In some embodiments, the first targeted message 152, the second targeted message 154, the third targeted message 156 and the fourth targeted message 158 have been created by operators of their respective sources (i.e. one of the first source 130, the second source 132 and the third source 134). While in other embodiments, the first targeted message 152, the second targeted message 154, the third targeted message 156 and the fourth targeted message 158 have been created by operators of the targeted message server 140 based on instructions provided from respective sources of the first targeted message 152, the second targeted message 154, the third targeted message 156 and the fourth targeted message 158 (i.e. one of the first source 130, the second source 132 and the third source 134).

Simply for the sake of illustration, let it be assume that the first source 130 is associated with a Reifeizen Bank Russia, which organization operates a web site available at http://www.raiffeisen.ru/en/. The second source 130 is associated with Lufthansa German Airlines, which organization operates a web site available at www.lufthansa.com. Finally, the third source 134 is associated with a recommendation web “Luchshiye.com”, which organization operates a web site available at www.luchshiye.com and provides a list of favorite resource in various categories, such as points of interests, banks, food and drinks, music, movies and the like. It should be noted that the first source 130, the second source 132 and the third source 134 have been provided as examples only and that the type and/or the number of sources of targeted messages present within architecture of the system 100 can vary.

Naturally, each of the sources of the respective first targeted message 152, the second targeted message 154, the third targeted message 156 and the fourth targeted message 158 may have entered into an agreement with the targeted message server 140 for placing the first targeted message 152, the second targeted message 154, the third targeted message 156 and the fourth targeted message 158 onto SERPs provided by the server 114 or for placement on other web sites associated with the ad service provided by the targeted message server 140.

Let it be assumed that the first targeted message 152 is associated with the first source 130 (i.e. Reifeizen Bank Russia) and, as such, the first targeted message 152 can be embodied as a banner ad associated with banking services provided by the Reifeizen Bank Russia (let's assume it is a promotional banner for the new VISA Platinum Card).

Let it be assumed that the second targeted message 154 is associated with the second source 132 (i.e. Lufthansa German Airlines) and, as such, the second targeted message 154 can be embodied as a banner ad associated with services provided by Lufthansa (let's assume it is a promotional banner for the new World Travel Pass).

Let it be assumed that the third targeted message 156 and the fourth targeted message 158 are associated with the third source 134 (i.e. “Luchshiye.com” suggestion web site) and, as such, the third targeted message 156 and the fourth targeted message 158 can be embodied as a banner ads for various services provided by the suggestion web site. Let it be assume, that the third targeted message 156 is a banner ad for the “Best Banks” section of the suggestion web site, while the fourth targeted message 156 is a banner ad for the “Best Credit Cards” section of the suggestion web site.

In some embodiments of the present technology, the targeted message server 140 can maintain a mapping of the targeted message (the targeted message server 140 for placing the first targeted message 152, the second targeted message 154, the third targeted message 156 and the fourth targeted message 158) to the associated source and/or to the associated target domain (as, for example, a BannerID-TargetDomainID mapping). In some embodiments, the mapping is done based on the landing page of the source. In other embodiments, the mapping is done up to a second level sub-domain off the landing page of the source.

In some embodiments of the present technology, in order to select one or more of the targeted messages (the targeted message server 140 for placing the first targeted message 152, the second targeted message 154, the third targeted message 156 and the fourth targeted message 158) for placement onto SERPs provided by the server 114 or for placement on other web sites associated with the ad service provided by the targeted message server 140, the targeted message server 140 is configured to execute a targeted message selection routine.

In some embodiments of the present technology, as part of the targeted message selection routine, the targeted message server 140 is configured to assign, to each of the first targeted message 152, the second targeted message 154, the third targeted message 156 and the fourth targeted message 158 (and other targeted messages potentially maintained within targeted message database 142) a click-through rate (CTR) estimation.

Generally speaking, the click-through rate (CTR) of an on-line advertisement is defined as the number of clicks on an the ad divided by the number of times the ad is shown to the user (impressions) on either a SERP or another web site media, expressed as a percentage.

For example, if a banner ad is delivered 100 times (100 impressions) and receives one click, then the click-through rate for the advertisement would be 1%.

The purpose of click-through rates is to capture customers' initial response to the given ad. Most commercial ads placed on the SERP or another web site media are designed to elicit some sort of action from the user viewing the given ad—whether it be to buy a book, book an airline ticket, watch a music video, or apply for a new credit card.

Marketers (both people placing the given ad and people administering the on-line ad system) want to know the reaction of the users to the ad. The click-through rate is used as a proxy for the user reaction to the ad. The click-through rate measures the proportion of visitors who initiated action with respect to an advertisement that redirected them to another page where they might purchase an item or learn more about a product or service. The higher the click-through rate for a given ad is, the more successful it can be said to be. Continuing with our example of a banner ad with 100 impressions, if 50 people clicked on it and executed the action that the ad was meant to solicit, the CTR would be 50%—denoting a much higher success rate than the above 1% example.

Above numbers were provided purely for illustration. Nowadays, it is reported, that click-through rates for banner ads average between 0.2% and 0.3%. In most cases, a 2% click-through rate would be considered very successful. Since advertisers typically pay more for a high click-through rate, getting many click-throughs with few purchases is undesirable to advertisers Similarly, by selecting an appropriate advertising site with high affinity (e.g., a on-line movie magazine for placement of a movie advertisement), the same banner can achieve a substantially higher CTR.

The targeted message server 140 is configured to assign a predicted CTR to each of the targeted messages stored in the targeted messages database 142—i.e. each of the first targeted message 152, the second targeted message 154, the third targeted message 156 and the fourth targeted message 158 (and other targeted messages potentially maintained within targeted message database 142). The predicted CTR is instrumental in allowing the targeted message server 140 to select one or more of the targeted messages—i.e. the first targeted message 152, the second targeted message 154, the third targeted message 156 and the fourth targeted message 158 (and other targeted messages potentially maintained within targeted message database 142) in response to a particular search query based on the targeting policy established by the operator of the targeted message server 140.

According to embodiments of the present technology, the targeted message server 140 is configured to adjust the predicted CTR associated with one or more given ones of the first targeted message 152, the second targeted message 154, the third targeted message 156 and the fourth targeted message 158 (and other targeted messages potentially maintained within targeted message database 142) in response to the one or more given ones being associated with a target resource that is responsive to a given navigational query.

In some embodiments, to generate the adjusted CTR, the targeted message server 140 adjusts the predicted CTR with an adjustment value. In some embodiments of the present technology, the adjustment value is determined experimentally. In some embodiments, the adjustment value is the same for all targeted messages that are potentially associated with navigational queries. In alternative embodiments of the present technology, the adjustment value can be different for different targeted messages that are potentially responsive to navigational queries. In yet alternative embodiments, the adjustment value can be determined based on various machine learning techniques.

The adjustment value can be chosen based on the type or nature of the navigational query, region associated with the user or the resource associated with the navigational query, specific types of resources associated with navigational queries, etc.

In yet alternative embodiments, the adjustment value does not need to be based on an additive function. For example, the adjustment value can be based on a coefficient function or can be based on a more complex computational formulae.

In some embodiments, after the predicted CTR has been adjusted with the adjustment value to generate an adjusted CTR, the adjusted CTR is normalized by the sigmoid function (in order for it not to fall out of the range 0 . . . 1). Generally speaking, the adjustment value is selected to be large enough to ensure that the adjusted CTR ensures that the targeted message associated with the adjusted CTR is selected in response to the navigational search query. As such, it should be understood that specific targeting policy needs to be taken into account when selecting the adjustment value to ensure that the adjustment value renders the associated targeted message selectable in response to the navigational search query.

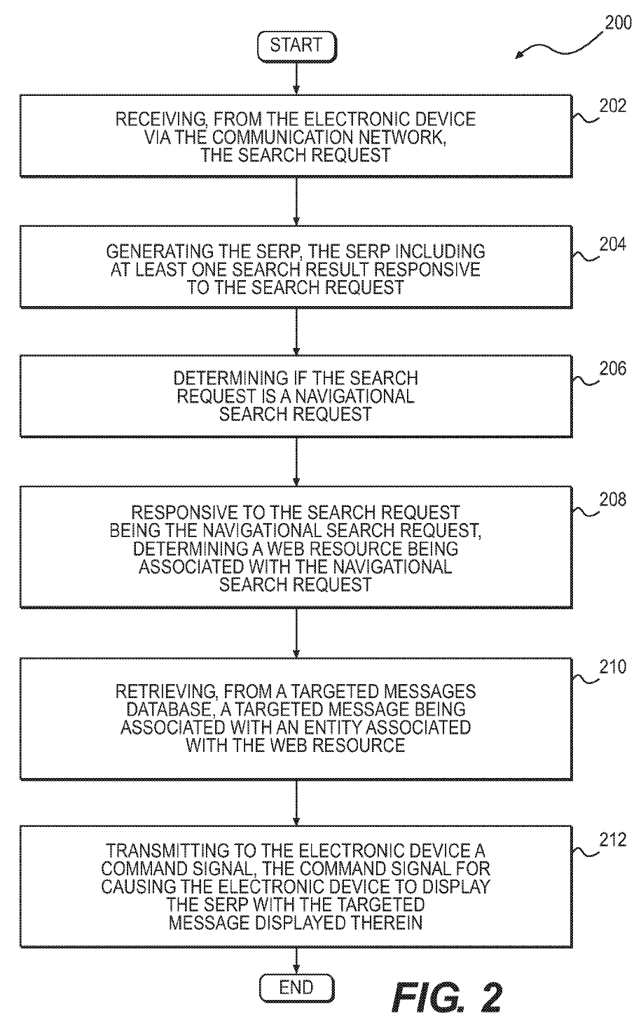

Given the architecture of the system 100 of FIG. 1 and the examples provided herein above, it is possible to execute a method of selecting a targeted message for inclusion into a Search Engine Results Page (SERP), the SERP having been generated in response to a search query. The method can be executable on the server 114, which server 114 is responsive for conducting searches for search queries submitted by the user using the electronic device 102. With reference to FIG. 2, there is depicted a flow chart of a method 200, the method 200 being executed in accordance with non-limiting embodiments of the present technology.

Step 202—Receiving, from the Electronic Device Via the Communication Network, the Search Request

The method 200 begins at step 202, where the server 114 receives, from the electronic device 102 via the communication network 112, the search request.

In some embodiments of the present technology, step 202 can be executed in response to the user entering a search query using the omnibox 108 of the search application 104 associated with the electronic device 402.

Let it be assumed, that there are three scenarios for user-submitted search queries:

Scenario 1: the user has submitted the query: “Reifeizen Bank Russia”.

Scenario 2: the user has submitted the query: “Lufthansa German Airlines”.

Scenario 3: the user has submitted the query: “Best bank services, Moscow region”.

Step 204—Generating the SERP, the SERP Including at Least One Search Result Responsive to the Search Request

At step 204, the server 114 generates the SERP, the SERP including at least one search result responsive to the search request.

How step 204 is executed is not particularly limited, but generally speaking, as part of executing step 204, the server 114 transmits the search query to the search cluster 118 and the search cluster 118 returns the ranked search result list for generating the SERP.

The SERP includes one or more search results, the one or more search results being responsive to the search queries received as part of step 202.

Scenario 1: the SERP contains or more queries responsive to the search query: “Reifeizen Bank Russia”.

Scenario 2: the SERP contains or more queries responsive to the search query:

“Lufthansa German Airlines”.

Scenario 3: the SERP contains or more queries responsive to the search query: “Best bank services, Moscow region”.

Step 206—Determining if the Search Request is a Navigational Search Request

At step 206, the server 114 determines if the search request is a navigational search request.

In some embodiments of the present technology, the step of determining 206 if the search request is a navigational search request comprises analyzing the search request itself. For example, as part of determining 206, the server 114 can access its internal mapping (i.e. the NavigSourceQuery mapping), which may have a pre-stored mapping, which correlates a particular navigational query to the associated target web resources to determine of the search query received as part of step 202 is indeed a navigation query (if its indication is contained in such pre-stored mapping).

In some embodiments of the present technology, the step of determining 206 if the search request is a navigational search request comprises analyzing a top search result generated for the search request as part of step 204. Within these embodiments, the top search result may be associated with the web domain that has been pre-determined to be a target web resource associated with the navigational query (which pre-determination may have been stored in the internal memory of the server 114).

In some embodiments of the present technology, the step of determining 206 if the search request is a navigational search request comprises analyzing past click information, past click information being representative of a most frequent resource selected by other users performing past searches similar to the search request. As has been explained above, the server 114 can analyze log data representative of past searches executed by other users and search results past users have selected, where the past searches have been executed with the same or similar search query.

In some embodiments, the server 114 analyzes the log data with the view to identify the top search result presented to the past users executing same or similar searches. In other embodiments, the server 114 analyzes the log data with the view to identify the top search result selected by the past users executing same or similar searches. For example, the server can determine if a particular web site has been selected from the search results, and that particular web site is selected by a pre-determined number of users per day—that can be indicative of the search query to be a navigational query and such the web site can be deemed to be the target of such the navigational query.

Using the above examples, the server 114 can make the following determinations:

Scenario 1: the server 114 determines that the search query: “Reifeizen Bank Russia” in a navigational query.

Scenario 2: the server 114 determines that the search query: “Lufthansa German Airlines” is a navigational query.

Scenario 3: the server 114 determines that the search query: “Best bank services, Moscow region” is not a navigational query.

Step 208—Responsive to the Search Request Being the Navigational Search Request, Determining a Web Resource Being Associated with the Navigational Search Request

At step 208, the server 114 responsive to the search request being the navigational search request, determines a web resource being associated with the navigational search request.

In some embodiments of the present technology, the server 114 may maintain an internal mapping (i.e. the aforementioned NavigSourceDomain mapping) of correspondence of a given navigational query and the associated target web resource.

Using the aforementioned examples, the server 114 can maintain in an internal memory (not depicted) the following NavigSourceDomain mapping of navigational queries and the associated target web resources:

<Query><Entity><URLhttp://www.raiffeisen.ru/en/>
<?Reifeizen?><Reifeizen Bank Russia><http://www.raiffeisen.ru/en/>
<?Lufthansa><Lufthansa German Airlines><www.lufthansa.com>
<?“Luchshiye.com”?> <Luchshiye.com Web Site><www.luchshiye.com>

It should be expressly understood that the above example of the NavigSourceDomain mapping has been provided for illustration purposes only. The NavigSourceDomain may contain more or fewer fields, different or additional information, etc. The information in the

NavigSourceDomain may be split between or more other mappings (such as some of the other mappings described here).

Based on the above NavigSourceDomain mapping, the server 114 can determine the web resource and the associated entity associated with the navigational search query.

For example, the server 416 makes the following determinations:

Scenario 1: the server 114 determines that the web resource associated with the navigational search query “Reifeizen Bank Russia” is <http://www.raiffeisen.ru/en/>.

Scenario 2: the server 114 determines that the web resource associated with the navigational search query: “Lufthansa German Airlines” is <www.lufthansa.com>.

Scenario 3: the server 114 determines that there is no web resource associated with the navigational search query: “Best bank services, Moscow region”, as this search query is not a navigational search query.

In some embodiments, the step of determining 208 a web resource being associated with the navigational search request comprises selecting the web resource based on its URL.

Step 210—Retrieving, from a Targeted Messages Database, a Targeted Message being Associated with an Entity Associated with the Web Resource

At step 210, the server 114 retrieves, from the targeted messages database 142, a targeted message being associated with an entity associated with the web resource.

Based on the web resources, the server 114 accesses the targeted message server 140 and the targeted message server 140 retrieves from the targeted message database 142, an indication of the targeted message. In some embodiments of the present technology, the targeted message server 140 can identify the specific targeted message based on the aforementioned BannerID-TargetDomainID mapping.

Continuing with the above scenarios:

Scenario 1: the server 114 receives from the targeted message server 140, the first targeted message 152, which is specifically associated with the target web resource associated with the navigational search query being submitted as part of this Scenario.

Scenario 2: the server 114 receives from the targeted message server 140, the second targeted message 154, which is specifically associated with the target web resource associated with the navigational search query being submitted as part of this Scenario.

Scenario 3: since it has been determined that the search query submitted in this Scenario is not a navigational search query, the server 114 receives the targeted messages selected by the targeted message server 140 based on the general targeting routines. More specifically, the server receives one or both of the third targeted message 156 and the fourth targeted message 158.

Step 212—Transmitting to the Electronic Device a Command Signal, the Command Signal for Causing the Electronic Device to Display the SERP with the Targeted Message Displayed Therein

At step 212, the server 114 transmits to the electronic device 102 a command signal, the command signal for causing the electronic device to display the SERP with the targeted message displayed therein. In some embodiments, the command signal can be embodied in a JSON message. But any other suitable format can be used, of course.

More specifically, the server 114 transmits to the electronic device 102 the command signal that causes the search application 104 to display the SERP that includes:

Scenario 1: the first targeted message 152.

Scenario 2: the second targeted message 154.

Scenario 3: the selected one of the third targeted message 156 and the fourth targeted message 158 or both the third targeted message 156 and the fourth targeted message 158 in a rotating carousel fashion.

In some embodiments of the present technology, the method 200 further includes the step of generating the SERP. In some embodiments, the step of generating the SERP comprises including a link to the web resource as part of a set of top search results. This can be particularly useful to the user, since the search request received as part of step 202 has been determined to be a navigational request and, hence, it points to the web resource. Therefore, the user is more likely to be satisfied with the SERP having the target domain presented to her as one of the top results, if not the top result.

In some embodiments of the method 200, the step of retrieving 210 comprises retrieving a plurality of targeted messages associated with the entity and the method 200 further comprises a step of selecting the targeted message from the plurality of targeted messages. Just as is the case with the above example of both the third targeted message 156 and the fourth targeted message 158 being relevant in Scenario 2, same can apply to the Scenario 1 and 2, where more than one targeted message is retrieved in response to the determination that the search query received as part of step 202 is a navigational search query.

In those embodiments, the step of selecting includes applying a targeted messages policy to the plurality of targeted messages so retrieved. The targeted message policy can be the same as applied by the targeted message server 140 when retrieving the targeted messages from the targeted message database 142 with the exception that it is applied on a subset of targeted message selected as part of step 210.

In some embodiments, where a plurality of targeted messages is retrieved. The command signal causes the search application 102 to display all of the selected targeted messages in a rotating carousel fashion. In other embodiments, where a plurality of targeted messages is retrieved, the command signal causes the search application 102 to display one of the selected targeted message, the one of the selected targeted messages having been selected using a targeting policy applied to the selected targeted messages.

In some embodiments of the present technology, as part of the method 200, the server 114 further determines a special placement of the targeted message within the SERP.

In some embodiments, the selection of the special placement is determined based on the targeting policy. As a specific example, the special placement can be on a top portion of the SERP above the at least one search result.

In some embodiments of the method 200, at a point of time before executing the step of receiving 202, the method 200 further includes uploading the targeted message to the targeted messages database 142. In some embodiments, as part of the uploading the targeted message server 140 associated the targeted message with an indication of the web resource. This indication can be stored in the targeted message database 142. For example, in association with each of the first targeted message 152, the second targeted message 154, the third targeted message 156 and the fourth targeted message 158, the targeted messages database 142 can store an indication of the URL associated with the entity associated with the first targeted message 152, the second targeted message 154, the third targeted message 156 and the fourth targeted message 158.

Hence, in some embodiments, the step of retrieving the targeted message being associated with an entity associated with the web resource is executed using said indication of the web resource (i.e. the URL or the like).

In some embodiments of the present technology, the method 200 further comprises, prior to the step retrieving, adjusting a predicted click-through rate of the targeted message to an adjusted click-through rate. In some embodiments of the present technology, the step of retrieving is executed on the basis of the adjusted click-through rate. As has been described above, the adjusted click-through rate is higher than the predicted click-through rate otherwise associated with the targeted message.

To assist the reader in understanding a specific non-limiting implementation of the method 200, the following alternative example will be provided.

In response to receiving the search query, the server 114 checks NavigSourceQuery if the search query has been mapped. If the search query has not been mapped, it is determined that the search query is not navigational.

If the NavigSourceQuery contains the search query, in some optional embodiments, the server 114 checks if the region of the navigational search query corresponds to the geo location of the electronic device 102.

If it is determined that the search query is navigations, the server 114 retrieves the target domain from the NavigSourceDomain.

The server 114 then determines the CTR adjustment value. The CTR adjustment value may have been previously stored for this type of the navigational query or the server 114 can determine the adjustment value in real time, as has been described above.

The nature of the targeted message is not particular limited. In some embodiments of the present technology, the targeted message can be a banner ad. The targeted message can be embodied in any other kind of a targeted message: a promotional message, an informational message, a banner ad, a text ad, and the like.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of selecting a targeted message for inclusion into a Search Engine Results Page (SERP), the method executable at a server coupled to an electronic device via a communication network, the method comprising:
receiving, from the electronic device via the communication network, a search request;
generating the SERP, the SERP including at least one search result responsive to the search request;
determining if the search request is a navigational search request;
responsive to the search request being the navigational search request, determining a single web resource, the single web resource being a target of the navigational search request;
retrieving, from a targeted messages database, a targeted message being pre-associated with an entity associated with the single web resource, the pre-associated targeted message being relevant to the entity associated with the single web resource;
transmitting to the user electronic device a command signal, the command signal for causing the electronic device to display the SERP with the targeted message pre-associated with the single web resource displayed therein.

2. The method of claim 1, wherein said retrieving comprises retrieving a plurality of targeted messages associated with the entity and wherein the method further comprises selecting the targeted message from the plurality of targeted messages.

3. The method of claim 2, wherein said selecting comprises applying a targeted messages policy to the plurality of targeted messages.

4. The method of claim 2, wherein said command signal is for causing the electronic device to display the SERP with at least some of the plurality of targeted messages displayed therein in a rotating carousel fashion.

5. The method of claim 1, wherein said determining if the search request is a navigational search request comprises analyzing the search request and a geo location associated with the electronic device.

6. The method of claim 1, wherein said determining if the search request is a navigational search request comprises analyzing a top search result generated for the search request.

7. The method of claim 1, wherein said determining if the search request is a navigational search request comprises analyzing past click information, past click information being representative of a most frequent resource selected by other users performing past searches similar to the search request.

8. The method of claim 1, further comprising determining a special placement of the targeted message within the SERP.

9. The method of claim 8, wherein said determining comprises applying a targeting policy to determine said special placement.

10. The method of claim 8, wherein said determining comprises selecting the special placement on a top portion of the SERP above the at least one search result.

11. The method of claim 1, wherein said determining the single web resource comprises selecting the single web resource based on its URL.

12. The method of claim 1, further comprising, prior to said receiving, uploading the targeted message to the targeted messages database.

13. The method of claim 12, said uploading further comprises associating the targeted message with an indication of the single web resource.

14. The method of claim 13, wherein said retrieving the targeted message being associated with an entity associated with the single web resource is executed using said indication of the single web resource.

15. The method of claim 1, wherein said generating the SERP comprises including a link to the single web resource as part of a set of top search results.

16. The method of claim 1, further comprising, prior to said retrieving, adjusting a predicted click-through rate of the targeted message to an adjusted click-through rate.

17. The method of claim 16, wherein said retrieving is executed on the basis of the adjusted click-through rate.

18. The method of claim 16, wherein said adjusted click-through rate is higher than the predicted click-through rate.

19. The method of claim 1, wherein the targeted message is a banner ad.

20. A server comprising:
a communication interface for communication with an electronic device via a communication network,
a processor operationally connected with the communication interface, the processor configured to:
receive, from an electronic device via a communication network, a search request;
generate the SERP, the SERP including at least one search result responsive to the search request;
determine if the search request is a navigational search request;
responsive to the search request being the navigational search request, determine a single web resource, the single web resource being a target of the navigational search request;
retrieve, from a targeted messages database, a targeted message being pre-associated with an entity associated with the single web resource, the pre-associated targeted message being relevant to the entity associated with the single web resource;
transmit to the user electronic device a command signal, the command signal for causing the electronic device to display the SERP with the targeted message pre-associated with the single web resource displayed therein.

21.-38. (canceled)
